(19) United States
(12) Patent Application Publication
(10) Pub. No.: US 2014/0082529 A1
(43) Pub. Date: Mar. 20, 2014

(54) INFORMATION PROCESSOR, INFORMATION PROCESSING METHOD, AND INFORMATION PROCESSING PROGRAM

(71) Applicants: Kazushige Yamada, Osaka (JP); Masaaki Harada, Hyogo (JP); Hirokazu Kobayashi, Tokyo (JP)

(72) Inventors: Kazushige Yamada, Osaka (JP); Masaaki Harada, Hyogo (JP); Hirokazu Kobayashi, Tokyo (JP)

(73) Assignee: Panasonic Corporation, Osaka (JP)

(21) Appl. No.: 14/005,876

(22) PCT Filed: Jan. 25, 2013
(86) PCT No.: PCT/JP2013/000391

§ 371 Date: Sep. 18, 2013

(30) Foreign Application Priority Data
Jan. 27, 2012 (JP) 2012-015259

(51) Int. Cl. G06F 3/0482

(52) U.S. Cl. CPC G06F 3/0482
USPC 715/761

(57) ABSTRACT

An information processor (100) for information processing in a terminal having a plurality of image screens and has a transient state decision unit (130) that determines whether or not a terminal has shifted to a transient state between a first state and a second state from the first state in which a plurality of image screens is set in a first arrangement, or the second state in which a plurality of image screens is set in a second arrangement, and a display application decision unit (140); that causes the terminal to shift to an application decision operating mode that operates to determine one or a plurality of applications for successively showing a plurality of image screens from the normal operating mode that operates one or a plurality of applications for displaying a plurality of image screens under the condition that the terminal has shifted to the transient state.

### TECHNICAL FIELD

The present invention relates to an information processing apparatus, an information processing method, and an information processing program which are applied to a terminal capable of displaying a plurality of applications on a plurality of screens capable of being arranged in a switchable manner.

### BACKGROUND ART

In recent years, the share of cellular phones referred to as smart phones has been globally growing. In smart phones, individual users can install optional application software (hereinafter, referred to as an “application”) to freely expand functions and perform customization. Smart phones generally include a touch panel screen so that a user can operate an application that is being displayed, by touching the screen.

Smart phones having various shapes have emerged in response to the growing share thereof. A terminal including two screens (hereinafter, referred to as a “two-screen terminal”) is one of the above mentioned smart phones. For example, the two-screen terminal can switch between a state where the terminal is folded and exposes only one of the two screens and a state where the terminal is opened and exposes both of the two screens.

Patent Literature 1 discloses a technique of determining a display object after transition from the folded state (hereinafter, referred to as “one-screen state”) to the opened state (hereinafter, referred to as “two-screen state”). In the technique disclosed in Patent Literature 1, a menu in which a thumbnail of an image is used as a choice is displayed on one screen in the one-screen state or the two-screen state. In the technique disclosed in Patent Literature 1, an image corresponding to the thumbnail selected by a user's operation is displayed on the other screen. Such a technique allows a user's desired image to be displayed on a two-screen terminal in an image management application.

Incidentally, smart phones can be normally left while a plurality of applications are up and running, like a personal computer. Consequently, as in the technique disclosed in Patent Literature 1, a two-screen terminal is considered not only to display only one application on two screens but also to display a plurality of applications on different screens. Thus, the two-screen terminal can improve user's operation efficiency.

However, in such two-screen multitasking, the problem is how to determine a display object. This is because a choice of the display object includes not only whether to display only one application or two applications, but also which application to be displayed.

Consequently, Non-Patent Literature 1 discloses a technique of determining a display object in a two-screen state with respect to a terminal capable of two-screen multitasking. In the technique disclosed in Non-Patent Literature 1, a menu for selecting an application to be displayed is displayed when a specific operation, such as an operation of simultaneously touching two screens, is performed after the terminal transitions to the two-screen state. In addition, the technique disclosed in Non-Patent Literature 1 causes the terminal to transition to a display state (for example, a state where different applications are respectively displayed on the two screens) corresponding to a selection result in the menu. In such a technique, it is possible to cause a two-screen terminal supporting the two-screen multitasking to display a user's desired application.

### CITATION LIST

### Patent Literature

### PTL 1

Japanese Patent Application Laid-Open No. 2009-223486

### Non-Patent Literature

### NPL 1

“Kyocera ECHO User Guide”, [online], KYOCERA Corporation, [Searched on Jan. 19, 2012], Internet <URL:http://www.kyocera.co.jp/topics/2011/0201_waso.html>

### SUMMARY OF INVENTION

### Technical Problem

However, the technique disclosed in Non-Patent Literature 1 has a problem in that it takes effort to determine an application to be displayed next on each screen.

This is because a user has to individually perform an operation for displaying a menu and an operation for selecting an application. This is also because the operation for displaying the menu is required to be performed again when the operation is erroneously recognized in a terminal as an operation for an application that is being displayed. That is, this is because there is a possibility of, for example, a framework for realizing two-screen multitasking intercepting an input operation to the application that is being displayed, thereby affecting an operation of the terminal or bringing the terminal into an inoperable state.

Meanwhile, determining an application to be displayed next by using an operation trajectory pattern or the like, without displaying a menu, may be possible. However, in this case, there is a possibility of an operation for determining an application being erroneously recognized as the operation for an application that is being displayed.

An object of the present invention is to simply determine an application to be displayed next on a plurality of screens.

### Solution to Problem

An information processing apparatus according to an aspect of the present invention is an apparatus configured to perform information processing of a terminal including a plurality of screens, the apparatus including: a transient state determining section that determines whether or not the terminal has transitioned from one of a first state and a second state to a transient state which is a state between the first state and the second state, the first state being where the plurality of screens are fixed in a first arrangement, the second state being where the plurality of screens are fixed in a second arrangement; and a display application determining section that causes, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.

An information processing method according to another aspect of the present invention is a method of performing information processing of a terminal including a plurality of screens, the method including: determining whether or not the terminal has transitioned from one of a first state and a second state to a transient state which is a state between the first state and the second state, the first state being where the plurality of screens are fixed in a first arrangement, the second state being where the plurality of screens are fixed in a second arrangement; and causing, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.

An information processing program according to another aspect of the invention is a program for performing information processing of a terminal including a plurality of screens, the program causing a computer of the terminal to execute processing including: determining whether or not the terminal has transitioned from one of a first state and a second state to a transient state which is a state between the first state and the second state, to the first state being where the plurality of screens are fixed in a first arrangement, the second state being where the plurality of screens are fixed in a second arrangement; and causing, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.

### Advantageous Effects of Invention

According to the present invention, it is possible to simply determine an application to be displayed next on a plurality of screens.

### BRIEF DESCRIPTION OF DRAWINGS

FIG. 1 is a block diagram illustrating an example of a configuration of an information processing apparatus according to Embodiment 1 of the present invention;

FIGS. 2A to 2C are diagrams each illustrating a configuration and a state of transformation of a terminal according to Embodiment 2 of the present invention;

FIG. 3 is a block diagram illustrating an example of a configuration of an information processing apparatus according to Embodiment 2 of the present invention;

FIG. 4 is a flowchart illustrating an example of an operation of the information processing apparatus according to Embodiment 2 of the present invention;

FIG. 5 is a diagram illustrating an example of an appearance of an application selection screen in Embodiment 2 of the present invention;

FIGS. 6A to 6D are diagrams each illustrating an example of a display change pattern in a case of a first transformation pattern in Embodiment 2 of the present invention; and

FIGS. 7A to 7E are diagrams each illustrating an example of a display change pattern in a case of a second transformation pattern in Embodiment 2 of the present invention.

### DESCRIPTION OF EMBODIMENTS

Hereinafter, embodiments of the present invention will be described in detail with reference to the accompanying drawings.

### Embodiment 1

Embodiment 1 of the present invention is an example of a basic aspect of the present invention.

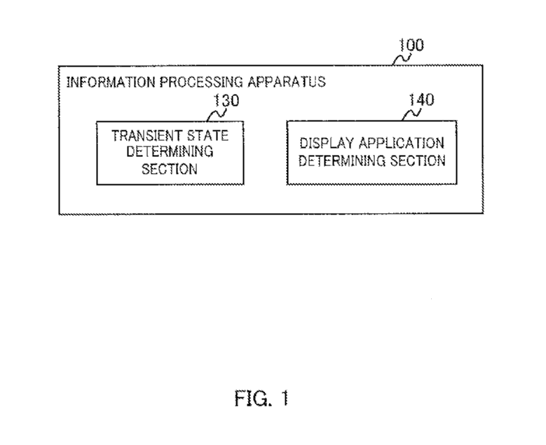

FIG. 1 is a block diagram illustrating an example of a configuration of an information processing apparatus according to the embodiment.

In FIG. 1, information processing apparatus 100 is an information processing apparatus that performs information processing of a terminal including a plurality of screens. Information processing apparatus 100 includes transient state determining section 130 and display application determining section 140.

Transient state determining section 130 determines whether the terminal has transitioned from a first state or a second state to a transient state.

The first state refers to a state where the plurality of screens are fixed in a first arrangement. For example, the first state is a state where two rectangular flat plate-shaped housings, each including a screen, overlap each other so as to expose only one screen.

The second state refers to a state where the plurality of screens are fixed in a second arrangement. For example, the second state is a state where the two housings are disposed next to each other so as to expose both the two screens.

The transient state refers to a state between the first state and the second state. For example, the transient state is a state in the process of being changed from the first state to the second state by sliding the two housings with respect to each other.

Display application determining section 140 causes the terminal to transition from a normal operation mode to an application determining operation mode, on condition that the terminal has transitioned to the transient state. The normal operation mode refers to an operation mode for performing an operation for one or a plurality of applications which are displayed on a plurality of screens. The application determining operation mode refers to an operation mode for performing an operation for determining one or a plurality of applications to be displayed next on a plurality of screens.

In addition, although not shown in the drawing, information processing apparatus 100 includes, for example, a CPU (central processing unit), a storage medium such as a ROM (read only memory) storing a control program, and a working memory such as a RAM (random access memory). In this case, a function of each of the sections described above is realized by causing the CPU to execute the control program.

Information processing apparatus 100 allows a user to perform an operation for selecting an application in a state where the operation is distinguished from an operation used in an application that is being displayed, without particularly performing an operation for displaying a menu. That is, information processing apparatus 100 can simply determine an application to be displayed next on a plurality of screens.

### Embodiment 2

Embodiment 2 of the present invention is an example of a detailed aspect in a case where the present invention is applied to a terminal (two-screen terminal) including two sliding screens.

<Screen Configuration of Terminal>

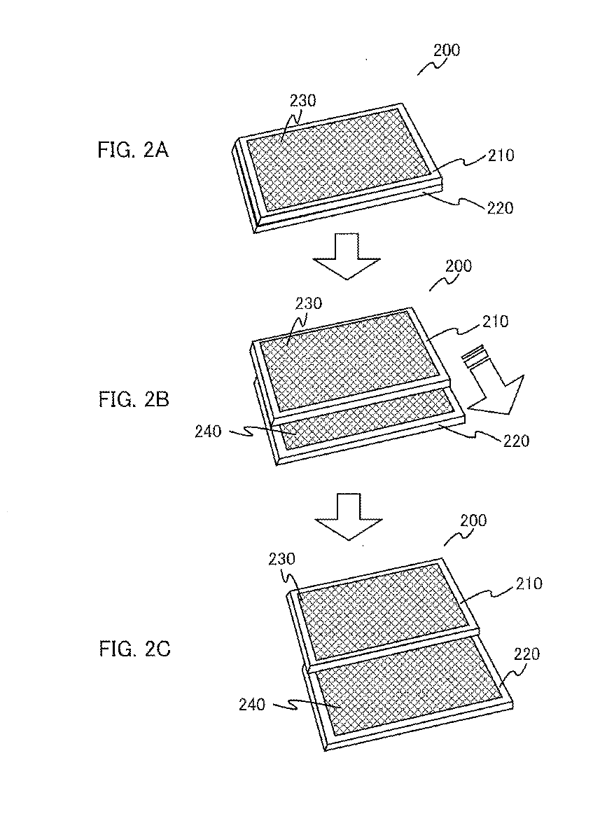

FIGS. 2A to 2C are diagrams each illustrating a configuration (screen configuration) and a state of transformation of a terminal to which the information processing apparatus according to this embodiment is applied.

As illustrated in FIGS. 2A to 2C, terminal 200 includes first housing 210 and second housing 220. First housing 210 and second housing 220 are rectangular flat plate-shaped housings having the approximately same size. First housing 210 includes first screen 230 on one surface in the principal plane thereof. Second housing 220 includes second screen 240 on one surface in the principal plane thereof.

Each of first screen 230 and second screen 240 is configured of an image display unit and an operation input unit. The image display unit is, for example, an LCD (liquid crystal display) or an organic EL (electro luminescence). The operation input unit is, for example, a touch panel. First screen 230 and second screen 240 (hereinafter, appropriately referred to as “two screens”) display an application or a standby screen, for example, under the control of an information processing apparatus to be described below.

As illustrated in FIG. 2A to FIG. 2C, first housing 210 and second housing 220 are connected to each other and slide with respect to each other in a state where both are substantially parallel to each other. In addition, first housing 210 and second housing 220 can be fixed in an arrangement in which only first screen 230 illustrated in FIG. 2A is exposed to the outside, and in an arrangement in which both the two screens illustrated in FIG. 2C are exposed to the outside. The state illustrated in FIG. 2B is a transient state at the time of displacement from the state illustrated in FIG. 2A to the state illustrated in FIG. 2C, or a transient state at the time of displacement from the state illustrated in FIG. 2C to the state illustrated in FIG. 2A. An arrangement relationship between first housing 210 and second housing 220 is realized using a slide mechanism and a locking mechanism which are not shown in the drawing.

That is, terminal 200 can switch the state illustrated in FIG. 2A, the state illustrated in FIG. 2B, and the state illustrated in FIG. 2C. The switching is performed by, for example, a user's manual operation.

In the description below, the state illustrated in FIG. 2A is referred to as a “first state,” and the state illustrated in FIG. 2C is referred to as a “second state”. The state (for example, the state illustrated in FIG. 2B) between the first state and the second state is referred to as a “transient state.”

In addition, transition to the second state through the transient state from the first state and transition to the first state through the transient state from the second state are referred to “transformation.” The start of the transition from the first state or the second state to the transient state, that is, the start of a sliding operation, is referred to “start of transformation.” The termination of the transition from the transient state to the first state or the second state, that is, the termination of the sliding operation, is referred to as “termination of transformation.”

Meanwhile, the process of the transformation of terminal 200 may have some patterns. Hereinafter, a transformation pattern in which the first state transitions to the second state is referred to as a “one screen-to-two screen transformation pattern.” A transformation pattern in which the second state transitions to the first state is referred to as a “two screen-to-one screen transformation pattern.” A transformation pattern in which the terminal slides slightly from the first state and then returns to the first state is referred to as a “one screen-to-one screen transformation pattern.” A transformation pattern in which the terminal slides slightly from the second state and then returns to the second state is referred to a “two screen-to-two screen transformation pattern.”

The information processing apparatus according to this embodiment is mounted within terminal 200. The information processing apparatus performs various types of information processing including processing for a display control of two screens.

<Configuration of Information Processing Apparatus>

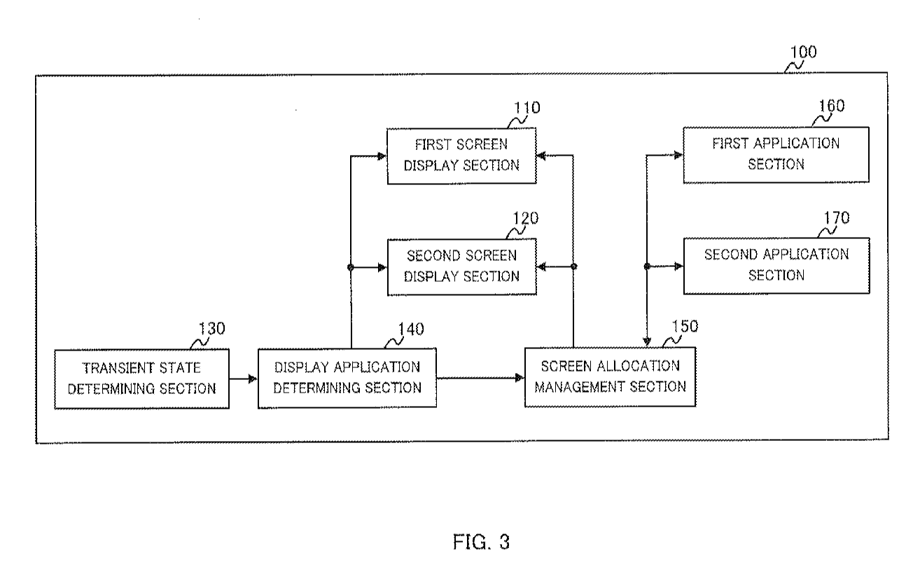

FIG. 3 is a block diagram illustrating an example of a configuration of information processing apparatus 100.

In FIG. 3, information processing apparatus 100 includes first screen display section 110, second screen display section 120, transient state determining section 130, display application determining section 140, screen allocation management section 150, first application section 160, and second application section 170.

First screen display section 110 is a display apparatus for displaying first screen 230 (see FIGS. 2A to 2C).

Second screen display section 120 is a display apparatus for displaying second screen 240 (see FIGS. 2A to 2C).

Transient state determining section 130 determines whether terminal 200 has transitioned to a transient state (see FIG. 2B).

More specifically when the transformation of terminal 200 is started, transient state determining section 130 detects the start of the transformation of the terminal. In addition, when the transformation of terminal 200 is terminated, transient state determining section 130 detects the termination of the transformation of the terminal. Transient state determining section 130 detects the start and termination of the transformation of the terminal, for example, on the basis of a detection signal of a contact sensor (not shown) for detecting a contact state between first housing 210 and second housing 220. When transient state determining section 130 detects the start of the transformation, the transient state determining section notifies display application determining section 140 of the start of the transformation, and when the transient state determining section detects the termination of the transformation, the transient state determining section notifies display application determining section 140 of the termination of the transformation.

Display application determining section 140 causes terminal 200 to transition from a normal operation mode to an application determining operation mode, on condition that terminal 200 has transitioned from the first state or the second state to the transient state. In addition, display application determining section 140 causes terminal 200 to transition from the application determining operation mode to the normal operation mode, on condition that terminal 200 has transitioned from the transient state to the first state or the second state.

More specifically, display application determining section 140 causes the operation of terminal 200 to transition from an operation of the normal operation mode to an operation of the application determining operation mode whenever the display application determining section is notified of the start of the transformation from transient state determining section 130. In addition, display application determining section 140 causes the operation of terminal 200 to transition from the operation of the application determining operation mode to the operation of the normal operation mode whenever the display application determining section is notified of the termination of the transformation from transient state determining section 130.

Meanwhile, display application determining section 140 may cause terminal 200 to transition to the application determining operation mode after the elapse of a predetermined period of time after the terminal transitions to the transient state. That is, display application determining section 140 may cause terminal 200 to transition from the normal operation mode to the application determining operation mode, on condition that the transient state has continued for a certain period of time or more.

In addition, when terminal 200 is in the application determining operation mode, display application determining section 140 may cause the terminal to transition to the normal operation mode on condition that at least one of the following has occurred: the transition is instructed by a user; another operation is started by a user; a predetermined period of time elapses; and an application is started. That is, display application determining section 140 may cause terminal 200 to transition from the application determining operation mode to the normal operation mode, on condition that one of the following situations has occurred: the transition is instructed by a user through a screen operation or the like; another operation is started by a user through an operation of an application being displayed; a predetermined period of time elapses; and an application start event such as detection of an incoming call or the like occurs.

Here, the normal operation mode refers to an operation mode for performing an operation for one or a plurality of applications which are displayed on two screens. In addition, the application determining operation mode refers to an operation mode for performing an operation for determining one or a plurality of applications to be displayed next on the two screens.

The application determining operation mode refers to an operation mode in which choices of a plurality of applications are displayed on a screen, which is exposed among two screens, and the selected application is determined to be an application to be displayed next on the two screens.

In this embodiment, the application determining operation mode is an operation mode in which an application selection screen for displaying choices of a plurality of applications is displayed on first screen 230. That is, display application determining section 140 instructs first screen display section 110 to display the application selection screen whenever the display application determining section is notified of the start of the transformation. Display application determining section 140 instructs first screen display section 110 not to display the application selection screen whenever the display application determining section is notified of the termination of the transformation.

In addition, when a user's selection operation is performed on the application selection screen, display application determining section 140 notifies screen allocation management section 150 of the selected application, and instructs the screen allocation management section to allocate the selected application as a display object to any one of the screens. In addition, in the case of the termination of the transformation in a state where the user's selection operation is not performed, display application determining section 140 notifies screen allocation management section 150 of the termination of the transformation, and instructs the screen allocation management section to display only an application that is displayed before the start of the transformation.

Screen allocation management section 150 starts an application, allocates the application to a screen, and performs a re-layout of the application such as the enlargement/reduction in size of an image, in accordance with the instruction from display application determining section 140.

First application section 160 is a functional section for realizing one of the plurality of applications that are installed in information processing apparatus 100. Such a plurality of applications include, for example, application software such as a mailer or the Internet browser. Herein, first application section 160 is used as a functional section for realizing an application (hereinafter, referred to as a “first application”) which is displayed on first screen 230 (see FIGS. 2A to 2C) immediately before.

Second application section 170 is a functional section for realizing one of the above-described plurality of applications. Here, when terminal 200 is in the second state immediately before, second application section 170 is used as a functional section for realizing an application (hereinafter, referred to as a “second application”) which is displayed on second screen 240 (see FIGS. 2A to 2C).

Meanwhile, although not shown in the drawing, information processing apparatus 100 is also provided with a functional section for realizing a third application different from the first application and the second application. For example, a screen of the third application may be displayed on first screen 230 or second screen 240.

In addition, although not shown in the drawing, information processing apparatus 100 includes, for example, a CPU, a storage medium such as a ROM storing a control program, and a work memory such as a RAM. In this case, a function of each of the sections described above is realized by causing the CPU to execute the control program.

Such information processing apparatus 100 allows a user to perform an operation for selecting an application in a state where the operation is distinguished from an operation used in an application that is being displayed, without particularly performing an operation for displaying a menu. That is, information processing apparatus 100 can simply determine an application to be displayed next on a plurality of screens.

<Operation of Information Processing Apparatus>

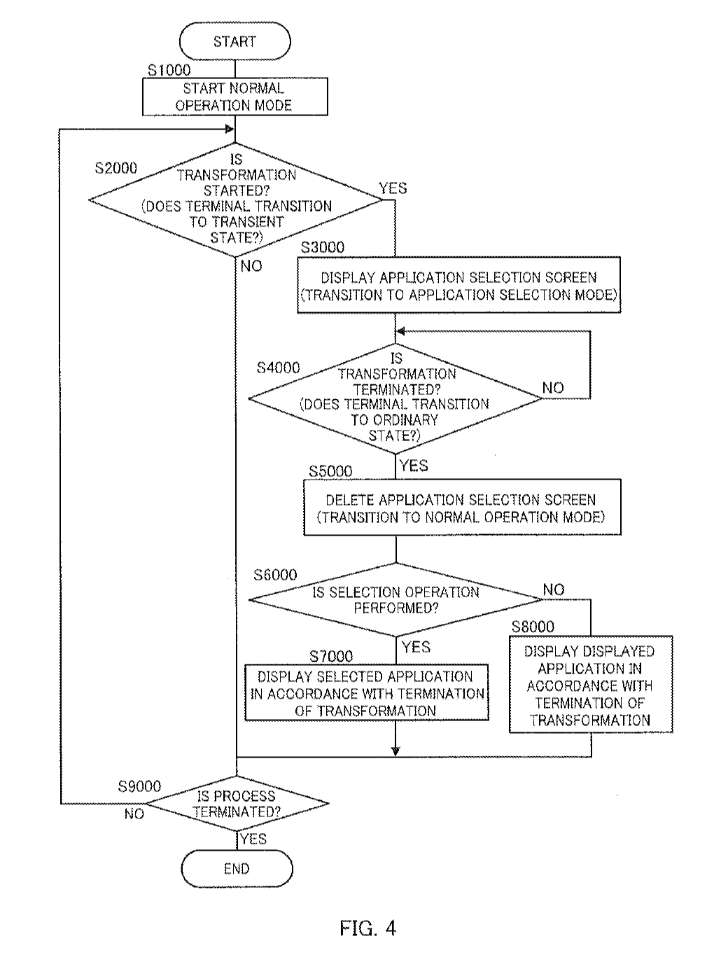

FIG. 4 is a flowchart illustrating an example of an operation of information processing apparatus 100.

First, in step S1000, display application determining section 140 starts the normal operation mode. That is, display application determining section 140 starts terminal 200 so as to set the terminal to be in a state where the terminal receives an ordinary user operation for an application that is displayed on a screen, without displaying the application selection screen.

Then, in step S2000, transient state determining section 130 determines whether transformation is started. That is, transient state determining section 130 determines whether terminal 200 has transitioned to a transient state.

When the transformation is not started (S2000:NO), transient state determining section 130 proceeds to step S9000 to be described below. In addition, when the transformation is started (S2000:YES), transient state determining section 130 notifies display application determining section 140 of the start of the transformation, and proceeds to step S3000.

In step S3000, display application determining section 140 displays the application selection screen. That is, display application determining section 140 causes terminal 200 to transition from the normal operation mode to an application selection mode.

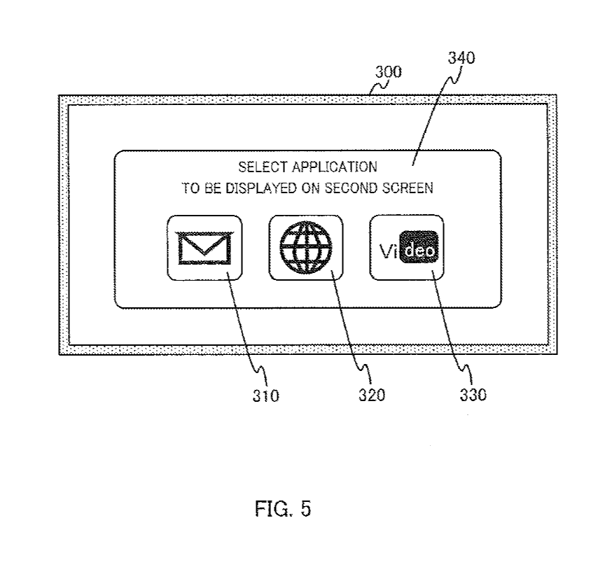

FIG. 5 is a diagram illustrating an example of an appearance of the application selection screen. Herein, an example of the application selection screen corresponding to only a one screen-to-two screen transformation pattern is illustrated.

As illustrated in FIG. 5, application selection screen 300 includes first to third icons 310 to 330 which are choices capable of being selected up to a maximum of two. In addition, application selection screen 300 includes message 340 for prompting a user to perform a selection operation for first to third icons 310 to 330, as a selection of an application to be displayed on the second screen.

For example, first icon 310 corresponds to the above-described first application. Then, second and third icons 320 and 330 respectively correspond to applications that are different from the first application.

Display application determining section 140 is configured such that an application to be displayed next on two screens is selected through application selection screen 300.

Then, in step S4000 of FIG. 4, transient state determining section 130 determines whether the transformation is terminated. That is, transient state determining section 130 determines whether terminal 200 has transitioned to the first state or the second state.

When the transformation is not terminated (S4000:NO), transient state determining section 130 repeats the determination process of step S4000. Then, when the transformation is terminated (S4000:YES), transient state determining section 130 notifies display application determining section 140 of the termination of the transformation, and proceeds to step S5000.

In step S5000, display application determining section 140 sets the application selection screen not to be displayed. That is, display application determining section 140 causes terminal 200 to transition from the application selecting operation mode to the normal operation mode.

In step S6000, display application determining section 140 determines whether a selection operation for any application is performed on the application selection screen.

When the selection operation with respect to any application is performed (S6000:YES), display application determining section 140 notifies screen allocation management section 150 of information indicating the selected application, and proceeds to step S7000. In addition, when the selection operation with respect to any application is not performed (S7000:NO), display application determining section 140 notifies screen allocation management section 150 of information indicating that the selection operation is not performed, and proceeds to step S8000.

In step S7000, screen allocation management section 150 appropriately starts the selected application and displays the application in accordance with a screen arrangement state after the transformation, and proceeds to step S9000 to be described below. That is, screen allocation management section 150 allocates each selected application as a display object to any screen. Then, screen allocation management section 150 acquires display image data from each application section in accordance with the allocation, appropriately performs enlargement/reduction processing or the like of an image, and outputs the image to each image display unit.

For example, it is assumed that second icon 320 is selected in application selection screen 300 illustrated in FIG. 5. In this case, screen allocation management section 150 allocates the first application to first screen 230, and allocates an application corresponding to second icon 320 to second screen 240. Meanwhile, as a result of the allocation, the application that is displayed on second screen 240 immediately before a certain transformation serves as the above-described second application.

In addition, in step S8000, screen allocation management section 150 displays the application that is displayed immediately before the transformation, in accordance with the screen arrangement state after the transformation, and proceeds to step S9000. That is, screen allocation management section 150 maintains a display object before the transformation as a display object after the transformation.

For example, it is assumed herein that second icon 320 (see FIG. 5) is selected. In this case, for example, screen allocation management section 150 allocates the first application to first screen 230, and allocates second icon 320 to second screen 240.

In addition, for example, it is assumed herein that none of first to third icons 310 to 330 is selected. In this case, for example, screen allocation management section 150 allocates only the first application to first screen 230 and second screen 240, and performs a re-layout such as the enlargement in size of an image.

Then, in step S9000, transient state determining section 130 determines whether the transient state determining section is instructed to terminate the process by a user's operation or the like.

When transient state determining section 130 is not instructed to terminate the process (S9000:NO), the transient state determining section proceeds to step S2000 to continue monitoring the start of the transformation. In addition, when transient state determining section 130 is instructed to terminate the process (S9000:YES), the transient state determining section terminates a series of processes.

Based on such an operation, information processing apparatus 100 can cause terminal 200 to transition from the normal operation mode to the application determining operation mode whenever terminal 200 transitions to the transient state. Then, information processing apparatus 100 can control a display state of terminal 200 in accordance with the determination performed in the application determining operation mode.

Meanwhile, as described above, the transformation pattern of terminal 200 includes four patterns, and the selection of an application includes several patterns for each transformation pattern. Therefore, a change in the display state includes a large number of patterns.

Hereinafter, an exemplary change pattern of a display state to be selected in the application determining operation mode will be described.

In the following description, a transformation pattern in which the first state (see FIG. 2A) transitions to the transient state (see FIG. 2B) is referred to as a “first transformation pattern”. In addition, a transformation pattern in which the second state (see FIG. 2C) transitions to the transient state (see FIG. 2B) is referred to as a “second transformation pattern.

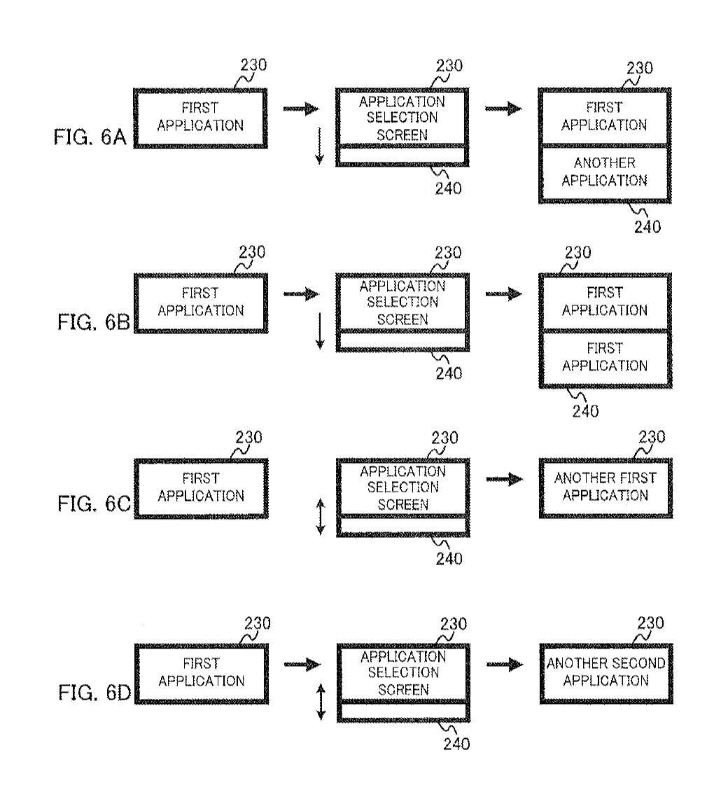

FIGS. 6A to 6D are diagrams each illustrating an example of a change pattern of a display state (hereinafter, referred to as a “display change pattern”) in a case of the first transformation pattern.

As illustrated in FIGS. 6A to 6D, the first transformation pattern is finally either the one screen-to-two screen transformation pattern (FIG. 6A and FIG. 6B) or the one screen-to-one screen transformation pattern (FIG. 6C and FIG. 6D).

In the case of transition to the second state, as illustrated in FIG. 6A, terminal 200 may be changed to a state where the first application is displayed on first screen 230 and another application is displayed on second screen 240. Alternatively, as illustrated in FIG. 6B, terminal 200 may be changed to a state where only the first application is displayed on two screens.

On the other hand, in the case of transition to the first state immediately after the transition to the transient state, terminal 200 may be changed to a state where another first application is displayed on first screen 230 as illustrated in FIG. 6C. Alternatively, as illustrated in FIG. 6D, terminal 200 may be changed to a state where another second application is displayed on first screen 230.

Therefore, it is preferable that the application determining operation mode be an operation mode in which a display state in the case of the one screen-to-two screen transformation pattern is selected from a group consisting of at least the display state illustrated in FIG. 6A and the display state illustrated in FIG. 6B. Furthermore, it is preferable that the application determining operation mode be an operation mode in which a display state in the case of the one screen-to-one screen transformation pattern is selected from a group consisting of at least the display state illustrated in FIG. 6C and the display state illustrated in FIG. 6D.

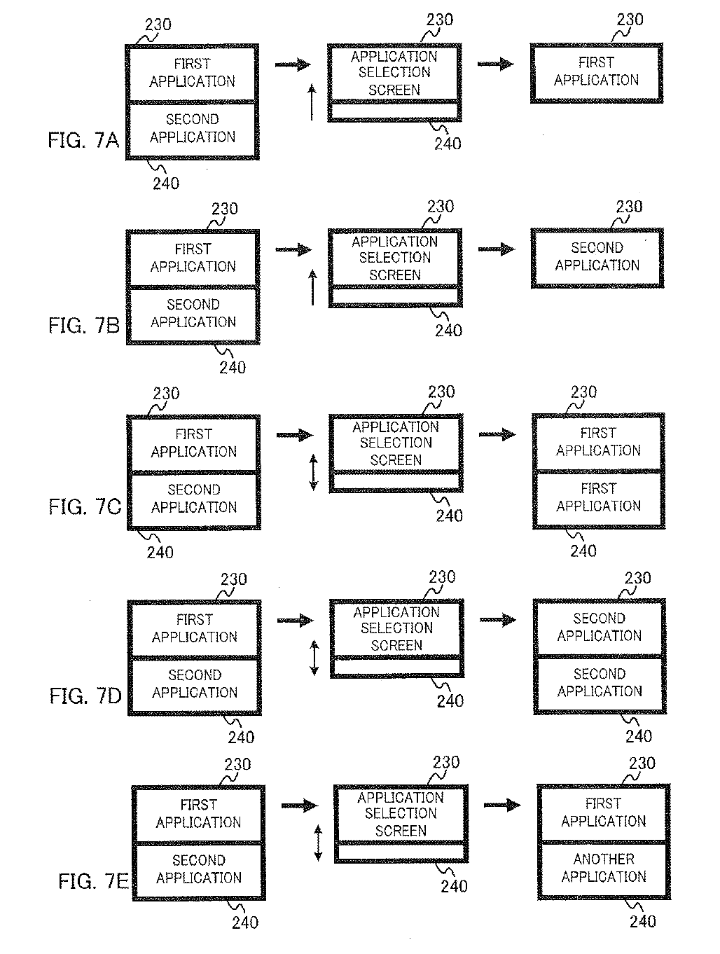

FIGS. 7A to 7E are diagrams each illustrating an example of a display change pattern in the case of the second transformation pattern.

As illustrated in FIGS. 7A to 7E, the second transformation pattern is finally any one of the two screen-to-one screen transformation pattern (FIG. 7A and FIG. 7B) and the two screen-to-two screen transformation pattern (FIG. 7C and FIG. 7D).

In the case of transition to the first state immediately after, terminal 200 may be changed to a state where the first application is displayed on first screen 230 as illustrated in FIG. 7A. In addition, terminal 200 may be changed to a state where the second application is displayed on first screen 230 as illustrated in FIG. 7B.

On the other hand, in the case of transition to the second state immediately after, terminal 200 may be changed to a state where only the first application is displayed on two screens as illustrated in FIG. 7C. Alternatively, terminal 200 may be changed to a state where only the second application is displayed on two screens as illustrated in FIG. 7D. Alternatively, terminal 200 may be changed to a state where the first application is displayed on first screen 230 and another application is displayed on second screen 240, as illustrated in FIG. 7E.

Therefore, it is preferable that the application determining operation mode be an operation mode in which a display state in the case of the two screen-to-one screen transformation pattern is selected from a group consisting of at least the display state illustrated in FIG. 7A and the display state illustrated in FIG. 7B. Furthermore, it is preferable that the application determining operation mode be an operation mode in which a display state in the case of the two screen-to-two screen transformation pattern is selected from a group consisting of at least the display state illustrated in FIG. 7C and the display state illustrated in FIG. 7D.

Meanwhile, in the application determining operation mode, it is advantageous that the display state in the case of the one screen-to-two screen transformation pattern is also capable of being selected from a display state where the first application is not displayed. In addition, in the application determining operation mode, it is advantageous that the display states in the cases of the two screen-to-one screen transformation pattern and the two screen-to-two screen transformation pattern are capable of being selected from the display state where the third application is displayed. Thus, information processing apparatus 100 can improve the degree of freedom of selecting a display object, and can improve the operability of terminal 200.

As described above, when terminal 200 transitions to the transient state, information processing apparatus 100 according to this embodiment detects the transition of the terminal. Information processing apparatus 100 causes terminal 200 to transition from the normal operation mode to the application determining operation mode, on condition that terminal 200 has transitioned to the transient state.

Thus, as in the related art, information processing apparatus 100 can receive an operation for selecting an application without having to perform a particular operation before or after the transformation of terminal 200. Therefore, information processing apparatus 100 can start multitasking by a simple procedure without obstructing the operation of the application.

That is, information processing apparatus 100 can simply determine applications to be displayed next on first screen 230 and second screen 240, and thus can reduce the complexity of a user's operation.

Meanwhile, in the above-described embodiment, the information processing apparatus displays the application selection screen on the first screen, but may display the application selection screen on an exposed portion of the second screen instead of the first screen.

In addition, the information processing apparatus is configured such that an application is selected by a display of the application selection screen, but is not limited thereto.

For example, the information processing apparatus may be configured such that the application is selected, by storing an operation trajectory pattern in advance in each application and comparing a pattern of an operation trajectory performed by a user with the operation trajectory pattern. That is, the application determining operation mode may be an operation mode in which an application to be displayed next on a plurality of screens is determined based on the operation pattern (for example, the pattern of the operation trajectory) of the user with respect to a screen, which is exposed among two screens.

In addition, when the terminal includes a three-dimensional acceleration sensor, the three-dimensional acceleration sensor can detect acceleration corresponding to a change in the terminal whenever a user changes the position and direction of the terminal. Consequently, for example, the information processing apparatus may be configured such that the application is selected, by storing an acceleration change pattern in advance in each application and comparing a change pattern of the acceleration corresponding to the change in the terminal with the acceleration change pattern. That is, the application determining operation mode may be an operation mode in which an application to be displayed next on a plurality of screens is determined based on the change pattern of the acceleration corresponding to the change in the terminal.

In addition, the terminal is not limited to a sliding type terminal. For example, the terminal may be a type in which the first housing and the second housing are folded, or may be a type in which the first housing and the second housing are located in a relatively skew position. In addition, the terminal may include three or more screens as long as the terminal can fix each screen in two or more relatively different arrangements.

In addition, the information processing apparatus may perform the determination of the start of the transformation and the determination of the termination of the transformation by using various types of components, such as an optical sensor or a physical switch, other than a contact sensor.

Meanwhile, the information processing apparatus in this disclosure may be, for example, the above-mentioned terminal, or a component (an LSI or the like) which constitutes the above-mentioned terminal. In addition, the information processing apparatus may be formed integrally with the terminal or may be formed as a separate housing.

In addition, in the above embodiment, although a hardware configuration is illustrated in this disclosure, this disclosure can also be realized by software in combination with hardware.

In addition, each functional block used in the description of the above-described embodiment is typically implemented by an LSI that is an integrated circuit. Each functional block may be formed as one chip, or one chip may be formed to include some or all the functional blocks. Here, while the LSI is used it may be referred also to as an IC, a system LSI, a super LSI, or an ultra LSI in accordance with a difference in the degree of integration.

Furthermore, a technique used for forming the integrated circuit is not limited to the LSI, but the integrated circuit may be implemented by a dedicated circuit or a general-purpose processor. A field programmable gate array (FPGA) that is programmable after the production of the LSI or a reconfigurable processor that can reconfigure connections or settings of circuit cells inside the LSI may be used.

In addition, when a technique for forming an integrated circuit that substitutes the LSI in accordance with the progress of the semiconductor technology or another derived technology appears, naturally, the functional blocks may be integrated by using the technology. Furthermore, there is a possibility that a biotechnology or the like can be applied.

An information processing apparatus of the disclosure is an apparatus configured to perform information processing of a terminal including a plurality of screens, the apparatus including: a transient state determining section that determines whether or not the terminal has transitioned from one of a first state and a second state to a transient state which is a state between the first state and the second state, the first state being where the plurality of screens are fixed in a first arrangement, the second state being where the plurality of screens are fixed in a second arrangement; and a display application determining section that causes, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.

In the information processing apparatus, the application determining operation mode may be an operation mode in which choices of a plurality of applications are displayed on the screen exposed among the plurality of screens, and the selected application is determined to be an application to be displayed next on the plurality of screens.

In the information processing apparatus, the application determining operation mode may be an operation mode in which an application to be displayed next on the plurality of screens is determined based on an operation pattern of a user with respect to the screen exposed among the plurality of screens.

In the information processing apparatus, the application determining operation mode may be an operation mode in which an application to be displayed next on the plurality of screens is determined based on a change pattern of acceleration corresponding to a change in the terminal.

In the information processing apparatus, the plurality of screens include a first screen and a second screen each including a touch panel; the first state is a state where only the first screen is exposed to the outside thereof; the second state is a state where both the first screen and the second screen are exposed to the outside thereof; and the application determining operation mode may be an operation mode in which, in a first transformation pattern that is a transformation pattern where the first state transitions to the transient state, a display state in case of transition to the second state immediately after the transition to the transient state is selected from a group consisting of at least a display state where only a first application is displayed on the first screen and the second screen, and a display state where the first application is displayed on the first screen and another application is displayed on the second screen, the first application being an application that has been displayed on the first screen immediately before the transition to the transient state.

In the information processing apparatus, the transient state determining section further determines whether or not the terminal has transitioned from the transient state to the second state; and the display application determining section may set the terminal to be in a display state where only the first application is displayed on the first screen and the second screen when the terminal transitions to the second state without selecting any display state in the application determining operation mode in the first transformation pattern.

In the information processing apparatus, the application determining operation mode may be an operation mode in which, in the first transformation pattern, a display state in the case of transition to the first state immediately after the transition to the transient state is further selected from a group consisting of at least a display state where the first application is displayed and a display state where the other application is displayed.

In the information processing apparatus, the application determining operation mode may be an operation mode in which, in a second transformation pattern that is a transformation pattern where the second state transitions to the transient state, a display state in case of transition to the first state immediately after the transition to the transient state is selected from a group consisting of at least a display state where the first application is displayed and a display state where a second application, which is an application that has been displayed on the second screen immediately before the second state transitions to the transient state.

In the information processing apparatus, the application determining operation mode may be an operation mode in which, in the second transformation pattern, a display state in the case of transition to the second state immediately after the transition to the transient state is further selected from a group consisting of at least a display state where only the first application is displayed on the first screen and the second screen, a display state where only the second application is displayed on the first screen and the second screen, and a display state where the first application is displayed on the first screen and another application is displayed on the second screen.

In the information processing apparatus, the display application determining section may cause the terminal to transition to the application determining operation mode after the elapse of a predetermined period of time after the terminal transitions to the transient state.

In the information processing apparatus, when the terminal is in the application determining operation mode, the display application determining section may cause the terminal to transition to the normal operation mode, on condition that at least one of the following situations has occurred: the transition is instructed by a user, another operation is started by a user; a predetermined period of time elapses; and an application start event occurs.

An information processing method of this disclosure is a method of performing information processing of a terminal including a plurality of screens, the method including: determining whether or not the terminal has transitioned from one of a first state and a second state to a transient state which is a state between the first state and the second state, the first state being where the plurality of screens are fixed in a first arrangement, the second state being where the plurality of screens are fixed in a second arrangement; and causing, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.

An information processing program of this disclosure is a program for performing information processing of a terminal including a plurality of screens, the program causing a computer of the terminal to execute processing including: determining whether or not the terminal has transitioned from one of a first state and a second state to a transient state which is a state between the first state and the second state, the first state being where the plurality of screens are fixed in a first arrangement, the second state being where the plurality of screens are fixed in a second arrangement; and causing, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.

The disclosure of Japanese Patent Application No. 2012-015259, filed on Jan. 27, 2012, including the specification, drawings and abstract, is incorporated herein by reference in its entirety.

### INDUSTRIAL APPLICABILITY

The present invention is suitable for use in an information processing apparatus, an information processing method, and an information processing program capable of simply determining an application to be displayed next on a plurality of screens. In particular, the present invention is suitable for various types of apparatuses, such as a smart phone, a tablet personal computer, a portable television, a game console, or a car navigation device, which include a plurality of screens configured to switch between the above mentioned first state, second state, and transient state.

### REFERENCE SIGNS LIST

100 Information processing apparatus
110 First screen display section
120 Second screen display section
130 Transient state determining section
140 Display application determining section
150 Screen allocation management section
160 First application section
170 Second application section
200 Terminal
210 First housing
220 Second housing
230 First screen
240 Second screen

1. An information processing apparatus configured to perform information processing of a terminal including a plurality of screens, the apparatus comprising:
a transient state determining section that determines whether or not the terminal has transitioned from one of a first state and a second state to a transient state which is a state between the first state and the second state, the first state being where the plurality of screens are fixed in a first arrangement, the second state being where the plurality of screens are fixed in a second arrangement; and
a display application determining section that causes, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.

2. The information processing apparatus according to claim 1, wherein
the application determining operation mode is an operation mode in which choices of a plurality of applications are displayed on the screen exposed among the plurality of screens, and the selected application is determined to be an application to be displayed next on the plurality of screens.

3. The information processing apparatus according to claim 1, wherein
the application determining operation mode is an operation mode in which an application to be displayed next on the plurality of screens is determined based on an operation pattern of a user with respect to the screen exposed among the plurality of screens.

4. The information processing apparatus according to claim 1, wherein
the application determining operation mode is an operation mode in which an application to be displayed next on the plurality of screens is determined based on a change pattern of acceleration corresponding to a change in the terminal.

5. The information processing apparatus according to claim 1, wherein:
the plurality of screens include a first screen and a second screen each including a touch panel;
the first state is a state where only the first screen among the first screen and the second screen is exposed to the outside thereof;
the second state is a state where both the first screen and the second screen are exposed to the outside thereof; and
the application determining operation mode is an operation mode in which, in a first transformation pattern that is a transformation pattern where the first state transitions to the transient state, a display state in case of transition to the second state immediately after the transition to the transient state is selected from a group consisting of at least a display state where only a first application is displayed on the first screen and the second screen, and a display state where the first application is displayed on the first screen and another application is displayed on the second screen, the first application being an application that has been displayed on the first screen immediately before the transition to the transient state.

6. The information processing apparatus according to claim 5, wherein:
the transient state determining section further determines whether or not the terminal has transitioned from the transient state to the second state; and
the display application determining section sets the terminal to be in a display state where only the first application is displayed on the first screen and the second screen when the terminal transitions to the second state without selecting any display state in the application determining operation mode in the first transformation pattern.

7. The information processing apparatus according to claim 5, wherein
the application determining operation mode is an operation mode in which, in the first transformation pattern, a display state in the case of transition to the first state immediately after the transition to the transient state is further selected from a group consisting of at least a display state where the first application is displayed and a display state where the other application is displayed.

8. The information processing apparatus according to claim 5, wherein
the application determining operation mode is an operation mode in which, in a second transformation pattern that is a transformation pattern where the second state transitions to the transient state, a display state in case of transition to the first state immediately after the transition to the transient state is selected from a group consisting of at least a display state where the first application is displayed and a display state where a second application, which is an application that has been displayed on the second screen immediately before the second state transitions to the transient state.

9. The information processing apparatus according to claim 8, wherein
the application determining operation mode is an operation mode in which, in the second transformation pattern, a display state in the case of transition to the second state immediately after the transition to the transient state is further selected from a group consisting of at least a display state where only the first application is displayed on the first screen and the second screen, a display state where only the second application is displayed on the first screen and the second screen, and a display state where the first application is displayed on the first screen and another application is displayed on the second screen.

10. The information processing apparatus according to claim 1, wherein
the display application determining section causes the terminal to transition to the application determining operation mode after the elapse of a predetermined period of time after the terminal transitions to the transient state.

11. The information processing apparatus according to claim 1, wherein
when the terminal is in the application determining operation mode, the display application determining section causes the terminal to transition to the normal operation mode, on condition that at least one of the following situations has occurred: the transition is instructed by a user; another operation is started by a user; a predetermined period of time elapses; and an application start event occurs.

12. An information processing method of performing information processing of a terminal including a plurality of screens, the method comprising:
determining whether or not the terminal has transitioned from one of a first state and a second state to a transient state which is a state between the first state and the second state, the first state being where the plurality of screens are fixed in a first arrangement, the second state being where the plurality of screens are fixed in a second arrangement; and
causing, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.

13. An information processing program for performing information processing of a terminal including a plurality of screens, the program causing a computer of the terminal to execute processing comprising:
determining whether or not the terminal has transitioned from one of a first state and a second state to a transient state which is a state between the first state and the second state, the first state being where the plurality of screens are fixed in a first arrangement, the second state being where the plurality of screens are fixed in a second arrangement; and
causing, on condition that the terminal has transitioned to the transient state, the terminal to transition from a normal operation mode for performing an operation on one or a plurality of applications displayed on the plurality of screens to an application determining operation mode for performing an operation for determining one or a plurality of applications to be displayed next on the plurality of screens.
